(19) United States
(12) Patent Application Publication
(10) Pub. No.: US 2009/0171830 A1
(43) Pub. Date: Jul. 2, 2009

(54) Payment Transaction System

(75) Inventor: Simon Blythe, Ely (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/964,859

(22) Filed: Dec. 27, 2007

(51) Int. Cl. G06Q 40/00; G06Q 20/00; G06F 3/00

(52) U.S. Cl. 705/37; 705/35; 705/41; 715/700

(57) ABSTRACT

A system for allocating a resource used in payment transactions is disclosed. The system includes an allocation module that allows a user of a payment device to specify a class of good or service and an allowable resource amount that can be charged to a user account for the selected class of good or service and a control module that authorizes a charge to the user account based on the selected class of good or service and the allowable resource amount.

### BACKGROUND OF THE INVENTION

1. Field of the Invention

The present invention generally relates to payment transaction systems, and more particularly to conducting a payment transaction using a pre-allocated resource.

2. Brief Description of the Related Art

Electronic payment systems are generally used around the world to conduct payment transactions. Instead of using cash, consumers are increasingly using payment devices to purchase a wide range of goods and services. The payment devices can include credit, debit, prepaid and smart cards, as well as cellular phones, personal digital assistants (PDAs), and other types of personal devices.

For example, a prepaid card allows a consumer to purchase a desired amount of good or service from a merchant. The card is referred to as ‘prepaid’ because the consumer purchases a certain amount of a good or service prior to actually receiving the good or service. This is in contrast to the more typical post-pay scenario where a consumer receives the good and service upon the charging of a consumer account. The consumer is then sent a bill for the amount charged.

With the increased availability of payment devices, consumers are increasingly using them to cover gaps in their spending. A result of this is that consumers are finding themselves in situations with increased financial burdens from which it can be difficult to recover.

Another issue relating to these devices is that they are especially vulnerable to theft and fraud. For example, because many of the devices tend to be small, it is easy for a thief to pocket a device unnoticed. Once stolen, the device could be used in a fraudulent transaction.

Accordingly, consumers and merchants have a need for an improved payment transaction system that can address these issues.

### SUMMARY OF THE INVENTION

A system for allocating a resource used in payment transactions is disclosed. The system includes an allocation module that allows a user of a payment device to specify a class of good or service and an allowable resource amount that can be charged to a user account for the selected class of good or service and a control module that authorizes a charge to the user account based on the selected class of good or service and the allowable resource amount.

Various aspects of the system relate to allocating a resource to a pre-selected class of good or service and authorizing a transaction based on the same. For example, according to one aspect, a system for conducting payment transactions includes a payment device capable of (1) specifying a class of good or service and an allowable first resource amount that can be charged to a user account for the specified class of good or service and (2) transmitting a transaction instruction to charge the user account a second resource amount for the specified class of good or service. The system also includes a transaction module for charging the user account the second resource amount for the specified class of good or service based on the allowable first resource.

In one preferred embodiment, the first resource amount is a monetary amount. In another preferred embodiment, the first resource amount is selected from the group consisting essentially of stocks, bonds, carbon credits, and derivative security interests.

Preferably, the payment device provides a graphical user interface to specify the class of good or service and the first resource amount. The payment device is preferably selected from the group consisting essentially of a smart card, magnetic stripe card, PDA, and cellular phone.

In one preferred embodiment, the transaction module compares the second resource amount to the first allowable resource amount and authorizes the transaction based on the comparison. The transaction module can also decrement the first allowable resource amount by the second resource amount.

In another preferred embodiment, the transaction module associates the decremented first allowable resource amount with the user account. Preferably, the transaction module stores the decremented first allowable resource amount in a data store.

In yet another preferred embodiment, the transaction module denies the transaction if the second resource amount exceeds the first allowable resource amount.

In another aspect of the invention, a method for conducting a payment transaction includes specifying a class of good or service and an allowable first resource amount that can be charged to a user account for the specified class of good or service, transmitting a transaction instruction to charge the user account a second resource amount for the specified class of good or service, and charging the user account the second resource amount for the specified class of good or service based on the allowable first resource.

In one preferred embodiment, the first resource amount is a monetary amount. In another preferred embodiment, the method includes selecting the first resource from the group consisting essentially of stocks, bonds, carbon credits and derivative security interests.

In another preferred embodiment, the method also includes providing a graphical user interface to specify the class of good or service and the first resource amount.

Preferably, the method also includes selecting the payment device from the group consisting essentially of a smart card, magnetic stripe card, PDA, and cellular phone.

In another preferred embodiment, the method includes comparing the second resource amount to the first allowable resource amount, and authorizing the transaction based on the comparison. The method can also include decrementing the first allowable resource amount by the second resource amount. Preferably, the method also includes associating the decremented first allowable resource amount with the user account. The method can also include storing the decremented first allowable resource amount in a data store.

In yet another preferred embodiment, the method also includes denying the transaction if the second resource amount exceeds the first allowable resource amount and allowing the transaction if the second resource amount does not exceed the first allowable amount.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of a payment transaction system according to the present invention.

FIG. 2 illustrates a payment device for use in the system of FIG. 1.

FIG. 3 illustrates an example graphical user interface for specifying a resource amount according to the present invention.

FIG. 4 is a flow chart of a method for conducting a payment transaction according to the present invention.

Like reference symbols in the various drawings indicate like elements.

### DETAILED DESCRIPTION OF THE PREFERRED EMBODIMENTS

FIG. 1 provides an illustrative representation of a payment transaction system 10 according to the present invention. The system 10 allows a consumer to specify a class of good or service and an allowable resource that can be charged to a user account for that specified good or service. The allowable resource can be specified as either a monetary amount or other medium of exchange. For example, in some preferred embodiments, the allowable resource can be specified in stocks, bonds, carbon credits as well as derivative security interests. The class of goods and services can include any good or service including, but not limited to, telephone service, gasoline, electricity, dry-cleaning, bus service, subway service, magazines, newspapers, or bundled goods and services. The system can be used by consumers to budget expenditures and minimizes the likelihood of fraud.

As shown in FIG. 1, in one preferred embodiment, the system 10 includes a payment device 12 capable of receiving and sending transaction information relating to specified classes of goods or services and a payment terminal 14 that may operate as a point of sale (POS) terminal for merchants.

The payment device 12 shown in FIG. 1 can be any type of personal computer device, including but not limited to a personal computer, such as a laptop computer, handheld computer, mobile phone, personal digital assistant (PDA), and/or any other device comprising electronic and/or magnetic components, such as a smart card and magnetic stripe card. Although only one payment device is shown in FIG. 1, the present invention is not limited to one payment device and can include a multitude of varied payment devices that are capable of communicating using various secure protocols.

The payment terminal 14 of the present invention is a computer device that operates as a point of sale terminal for goods or services rendered. As shown in FIG. 1, in one preferred embodiment, the payment terminal 14 includes a transaction module 14A for processing transaction instructions and displaying authorization messages. Details of the transaction module 14A are discussed in connection with FIG. 4 of the disclosure.

As shown in FIG. 1, in one preferred embodiment, the payment terminal 14 is in communication with a financial institution 16, such as a bank, which has access to a conventional payment network 18 in which the merchant has a financial account. A credit grantor 20 is also preferably in communication with the payment network 18 and provides a particular level of credit to the payment device user. As shown in FIG. 1, in one preferred embodiment, the credit grantor 20 includes 1) a server 20A that is configured to include a control module 20B for authorizing transactions based on pre-selected classes of goods and services and allowable resource amounts defined by payment device users and 2) an account datastore 20C for storing the pre-selected classes of goods and services and allowable resource amounts. Processing by the control module 20B is discussed in connection with FIG. 4 of the disclosure.

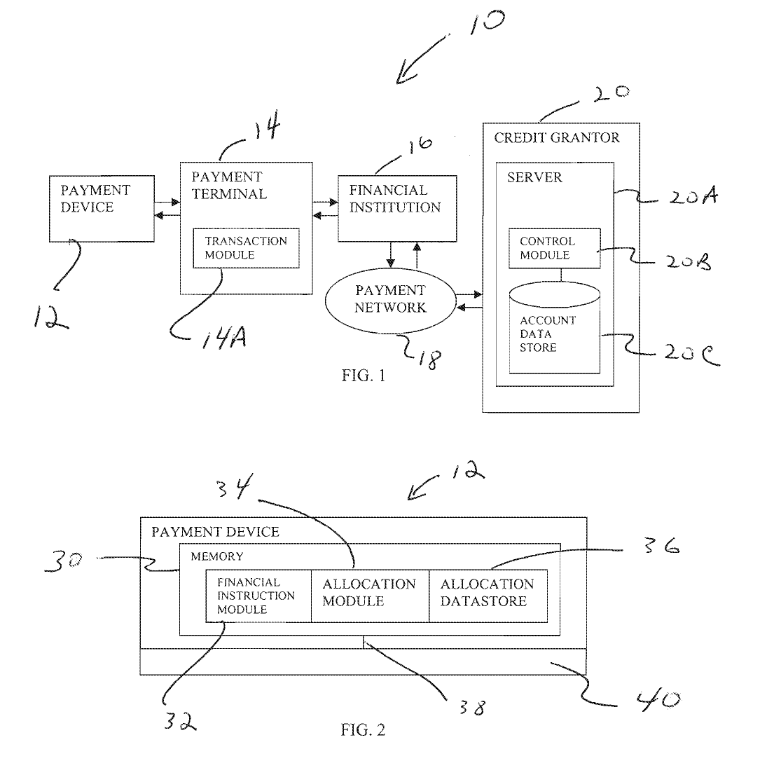

Referring now to FIG. 2, an example of a payment device that can be used in connection with the present invention is disclosed. As shown in the FIG. 2 example, the payment device 12 can be a smart card comprising a memory 30, an Input/Output (I/O) port 40 and a bus line 38 that connects the port 40 to the memory 30. In one preferred embodiment, the memory 30 of the device 12 is configured to include a financial instruction module 32, an allocation module 34 and an allocation datastore 36.

The financial instruction module 32 is used to provide programming instruction sets which are associated with, i.e., perform when interpreted and executed by the payment terminal 14, one or more transactions. In one preferred embodiment, the module 24 provides instructions to direct the payment terminal 14 regarding options (e.g., debit or credit card functionality) available to the user. Preferably, these options are pre-selected, meaning that the instructions associated with these options are pre-configured on the payment device 12 prior to use for a particular transaction.

In one preferred embodiment, the instructions provided by the instruction module 32 include an identification of any pre-selected classes of goods and services and allowable resource amounts that have been associated by the payment device user.

The allocation module 34 provides a graphical user interface that allows a user of the device 12 to preallocate resources (e.g., monetary amounts and other mediums of exchange) to particular classes of goods and services. In one preferred embodiment, the allocation module 30 provides a graphical user interface 50 that prompts the user to specify a class of goods or services and an allowable resource amount that can be expended in acquiring the specified class of good or service.

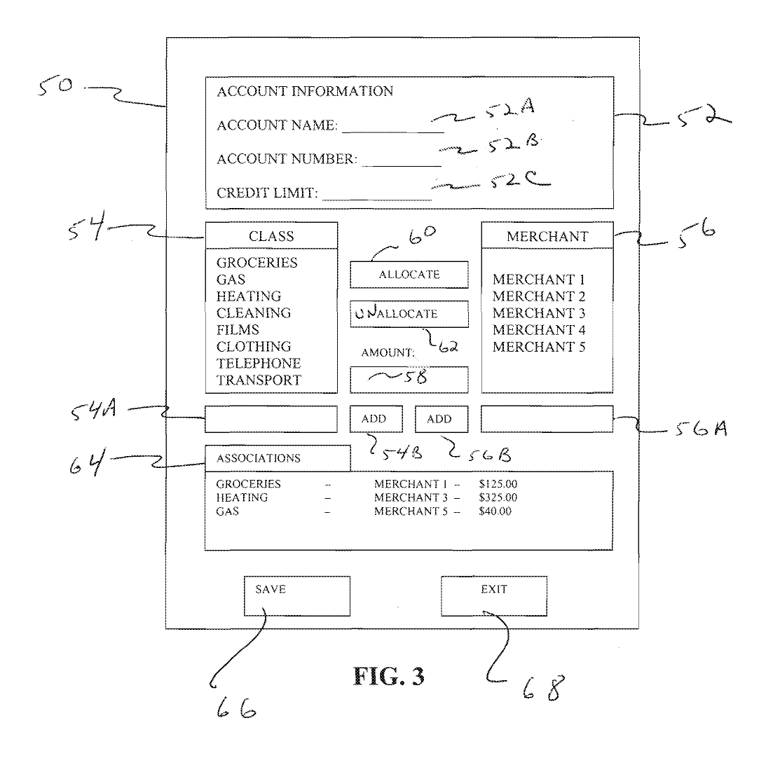

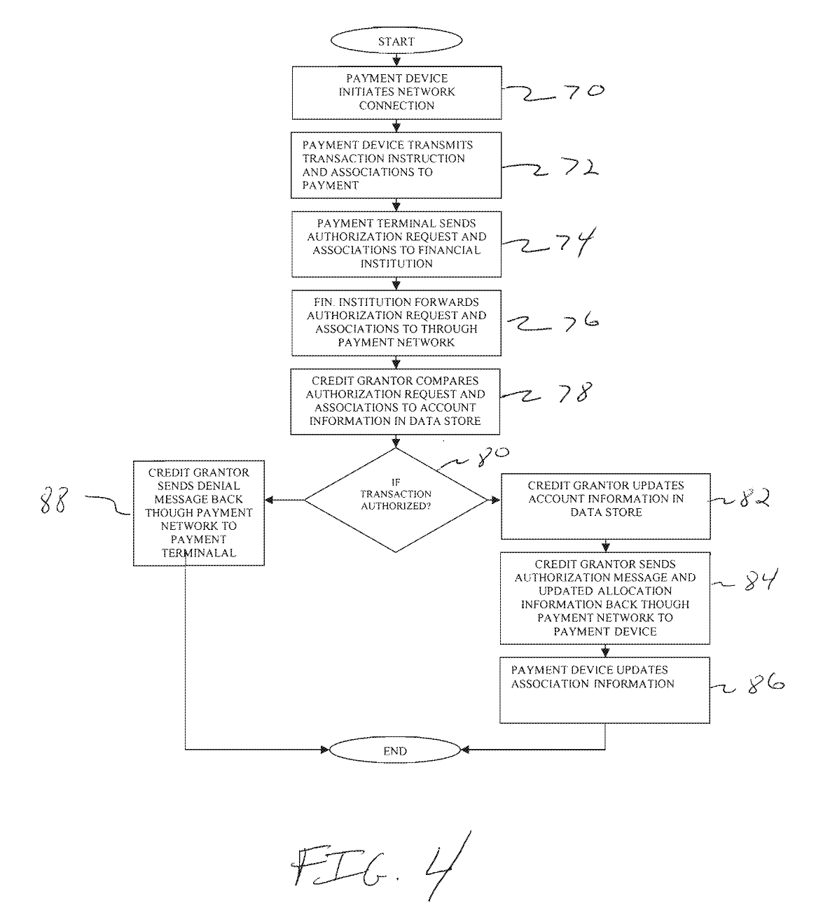

For example, in one preferred embodiment, upon attachment of the device 12 to a personal computer (PC), the allocation module 34 provides the graphical user interface 50 on a display device attached to the PC. Preferably, the PC is in communication with the server 20A of the credit grantor 20. In another preferred embodiment, the payment device 12 also includes a display area (not shown) to display the graphical user interface 50. An example of the graphical user interface provided by the allocation module 34 is discussed in connection with FIG. 3.

The allocation datastore 36 provides storage for one or more specified class of goods or services and resource amounts, as well as data items representative of a user's identity, such as account number, card expiration information, and security codes. In one preferred embodiment, contents of the datastore 36 are communicated directly to the payment terminal 14 upon commencement of a transaction. Information maintained in the datastore 36 also can be altered (updated, added to, or reduced) via the graphical user interface 50 and port 40 thus allowing for modification of good and service allocations.

Referring now to FIG. 3, an example graphical user interface 50 provided by the allocation module 34 is shown. As mentioned previously, the graphical user interface 50 allows the user of the system to specify one or more classes of goods and services and allowable resource amounts that can be expended for specified good or service classes.

As shown in FIG. 3, in one preferred embodiment, for example, the graphical user interface 50 includes an account information area 52 that displays detail account information relating to a particular user account. For example, as shown in FIG. 3, the account information area 52 can include an account name 52A, a unique account number 52B, as well as total amount of credit 52C available for the particular account.

In one preferred embodiment, the graphical user interface 50 includes a selectable class listing of goods and services 54 and a selectable listing of merchant identifiers 56, each of which may be associated with one another and a resource amount 58 upon selection of allocate button 60, and disassociated with one another upon selection of an unallocate button 58.

As shown in FIG. 3, in one preferred embodiment, user-defined classes of goods and services can be entered through category entry area 54A upon selection of add button 54B and then selected from the class list 54. Similarly, merchants providing particular classes of goods and services can be entered using merchant entry area 56A upon selection of add button 56B and then be selected from the merchant list 56. It will be appreciated by one skilled in the art that although a set of class and merchant lists are shown in FIG. 3, the present invention is not limited to these two lists and can include any number of sets of lists. In addition, it will be appreciated by one skilled in the art that the classes shown in FIG. 3 are merely exemplary, and that other types of goods and services can be entered and provided by the allocation module 34 for selection through the interface 50.

In one preferred embodiment, the graphical user interface 32 also includes a listing of associated classes 64 made using the payment device 12 with associated vendor information. For example, as shown in the FIG. 3 example, the first class of goods identified is ‘GROCERIES’ which are to be purchased from ‘MERCHANT 1.’ The total allowable resource amount that can be expended on this class at MERCHANT 1 has been specified to be ‘$125.00.’ Similarly, the last class displayed is ‘GAS’ which is the only good that can be purchased from ‘MERCHANT 5’ using the payment device. In addition, only ‘$40.00’ can be expended on this class at ‘MERCHANT 5.’

It will be appreciated by one skilled in the art that although the above allowable resource amounts are expressed in monetary terms, the present invention is not limited to monetary amounts. For example, in one preferred embodiment, allowable resource amounts are expressed in terms of number of shares of securities. In another preferred embodiment, allowable resource amounts are expressed in terms of carbon credits.

Once a user has specified a class of good or service and an allowable first resource amount that can be charged to a user account for the specified class of good or service, upon selection of a save button 66, the allocation module 34 stores the associations to the allocation datastore 36. In one preferred embodiment, where the allocation module 34 provides the graphical user interface 50 on a PC that is in communication with the server 20A, the control module 20B of the credit grantor 20 receives the associations from the allocation module 34 and stores the same to the account datastore 20C. Upon selection of an exit button 68, the allocation module 34 terminates the user interface 50.

Several advantages may stem from providing the payment device of the present invention. For example, by specifying an allowable resource amount that can be expended for a particular class of good or service at a particular merchant, consumers can gain better control of their expenditures. In addition, the likelihood of fraud based on illicit use of the payment device can be minimized as the device can only be used to purchase certain types of goods at particular merchant establishments.

Referring now to FIGS. 1 and 4, a typical transaction executed by the system using the techniques of the present invention will now be described. As shown in the FIG. 4 example, first, the payment device 12 initiates a network connection 70 to the payment terminal 14. In one preferred embodiment, where the payment device 12 is a cellular phone, a telephone company (TELCO) provider can be used as a gateway into one or more payment networks. In another preferred embodiment, where the payment device is a smart card, the payment device 12 initiates the network connection by polling for a wireless network connection as is known in the art. Preferably, the network connection is a secure connection that includes encryption and digital authentication.

Once the payment device 12 is connected to the payment terminal 14, the payment device 12 transmits a transaction instruction and specified associations 72 to the payment terminal 14. In one preferred embodiment, the transaction instruction includes one or more specified associations. In another preferred embodiment, the specified associations are transmitted to the payment terminal separate from the transaction instruction.

Upon transmission of the transaction instruction from the payment device 12 to the payment terminal 14, the transaction module 14A of the payment terminal 14 transmits to the financial institution 16 an authorization request for approval that includes a resource amount to charge a particular user account and a merchant identifier, and the specified associations 74. Next, the financial institution 16 forwards the authorization request and the specified associations through a conventional payment network 76 to the credit grantor 20.

In one preferred embodiment, the credit grantor 20 receives the authorization request and specified associations, the control module 20B of the server 20A compares the authorization request and received associations to account information for the user in the data store 78.

Based upon the payment device user's account status and control module 20B comparisons described below, the credit grantor can authorize or deny the authorization request 80.

For example, in one preferred embodiment, if the amount included in the authorization request exceeds the allowable resource amount included in the received association for the particular good or service, the control module 20B denies the transaction 80 and sends a denial message back through the payment network to the payment 10 terminal 88. In another preferred embodiment, the control module 20B also compares a merchant identifier included in the authorization request with the merchant identifier in the received association and if those values are not equivalent, the control module 20B denies the transaction.

Alternatively, in another preferred embodiment, if the amount included in the authorization request does not exceed the allowable resource amount included in the received association for the particular good or service, the control module approves the transaction 80. In yet another preferred embodiment, the control module 20B also compares a merchant identifier in the authorization request with the merchant identifier in the received association and if those values are equivalent and the amount included in the authorization request does not exceed the allowable resource amount included in the received association for the particular good or service, the control module approves the transaction 80.

If the transaction is authorized by the control module 20B, the control module 20B updates account information 82 for the account in the account datastore 20C. For example, in one preferred embodiment, the control module 20B decrements the allowable resource amount associated with a particular class of good or service for the particular user account by the resource amount specified in the authorization request. The control module then associates the decremented resource amount with the user account and class of good or service and stores the same in the account datastore 20C.

The control module 20B then transmits an authorization message and the updated resource amount 84 through the payment network to the payment device 12 through the transaction module 14A. Lastly, the allocation module 34 of the payment device 12 updates the allowable resource amount for the class of good or service 86 and stores the same in the allocation datastore 36.

A number of embodiments of the invention have been described. Nevertheless, it will be understood that various modifications may be made without departing from the spirit and scope of the invention. Also, the steps described above may be modified in various ways or performed in a different order than described above, where appropriate. Accordingly, alternative embodiments are within the scope of the following claims.

What is claimed is:

1. A system for conducting a payment transaction comprising:
a payment device capable of (1) specifying a class of good or service and an allowable first resource amount that can be charged to a user account for the specified class of good or service and (2) transmitting a transaction instruction to charge said user account a second resource amount for said specified class of good or service; and
a control module for charging said user account said second resource amount for said specified class of good or service based on said allowable first resource.

2. The system of claim 1, wherein said first resource amount is a monetary amount.

3. The system of claim 1, wherein said first resource amount is selected from the group consisting essentially of stocks, bonds, carbon credits and derivative security interests.

4. The system of claim 1, wherein said payment device provides a graphical user interface to specify said class of good or service and said first resource amount.

5. The system of claim 1, wherein said payment device is selected from the group consisting essentially of a smart card, magnetic stripe card, PDA, and cellular phone.

6. The system of claim 1, wherein said control module compares said second resource amount to said first allowable resource amount and authorizes said transaction based on said comparison.

7. The system of claim 6, wherein said control module decrements said first allowable resource amount by said second resource amount.

8. The system of claim 7, wherein said control module associates said decremented first allowable resource amount with said user account.

9. The system of claim 8, wherein said control module stores said decremented first allowable resource amount in a data store.

10. The system of claim 6, wherein said control module compares a first merchant identifier associated with said second resource amount to a second merchant identifier associated with said first allowable resource amount and authorizes said transaction based on said comparison.

11. The system of claim 1, wherein said transaction module denies said transaction if said second resource amount exceeds said first allowable resource amount.

12. A method for conducting a payment transaction comprising:
specifying a class of good or service and an allowable first resource amount that can be charged to a user account for the specified class of good or service;
transmitting a transaction instruction to charge said user account a second resource amount for said specified class of good or service; and
charging said user account said second resource amount for said specified class of good or service based on said allowable first resource.

13. The method of claim 12, wherein said first resource amount is a monetary amount.

14. The method of claim 12, comprising selecting said first resource from the group consisting essentially of stocks, bonds, carbon credits and derivative security interests.

15. The method of claim 12, comprising providing a graphical user interface to specify said class of good or service and said first resource amount.

16. The method of claim 12, comprising selecting said payment device from the group consisting essentially of a smart card, magnetic stripe card, PDA, and cellular phone.

17. The method of claim 12, comprising:
comparing said second resource amount to said first allowable resource amount; and
authorizing said transaction based on said comparison.

18. The method of claim 17, comprising decrementing said first allowable resource amount by said second resource amount.

19. The method of claim 18, comprising associating said decremented first allowable resource amount with said user account.

20. The method of claim 18, comprising storing said decremented first allowable resource amount in a data store.

21. The method of claim 17, further comprising:
comparing a first merchant identifier associated with said second resource amount to a second merchant identifier associated with said first allowable resource amount; and
authorizing said transaction based on said comparison.

22. The method of claim 12, comprising:
denying said transaction if said second resource amount exceeds said first allowable resource amount; and
allowing said transaction if said second resource amount does not exceed said first allowable amount.
